(19) United States
(12) Patent Application Publication
(10) Pub. No.: US 2014/0339017 A1
(43) Pub. Date: Nov. 20, 2014

(54) FireCoat FEDS (Fullbody Emergency Descent System)

(71) Applicant: Norman E. Wood, Poulsbo, WA (US)

(72) Inventor: Norman E. Wood, Poulsbo, WA (US)

(21) Appl. No.: 14/279,268

(22) Filed: May 15, 2014

Related U.S. Application Data
(60) Provisional application No. 61/824,058, filed on May 16, 2013.

(51) Int. Cl. A62B 1/14

(52) U.S. Cl. CPC A62B 1/14
USPC 182/5

(57) ABSTRACT

A full body emergency descent system (EDS) for incorporating into the coat and pants of a firefighter for allowing for safe escape from elevated heights. The EDS includes: a panel housing flame resistant rope or cable into the coat with a pair of chest straps that store away until needed and fasten together when needed; a pair of leg straps incorporated into the pants, said leg straps connecting to said chest straps through pocket accesses to form a full body harness. The EDS further includes a purposefully designed control descent rack in and through which the rope/cable is wound and a friction braking handle. Preferred embodiments further incorporate a drag strap loop.

### CROSS-REFERENCE TO RELATED APPLICATION

This application is a perfection of Provisional Application Ser. No. 61/824,058, filed on May 16, 2013, the disclosure of which is incorporated herein.

### BACKGROUND OF THE INVENTION

1. Field of the Invention

The present invention relates to an emergency descent system, or “EDS”. More particularly, this invention relates to an EDS that can be fully incorporated, both storage and during use, in the outerwear of a firefighter's gear, especially the coat and pants for the same. These lightweight, integral systems will be “available” any and every time thereby allowing its wearer to safely escape from the higher levels of a building, home or office in an atypical emergency. This invention uses flame resistant rope or cable for lowering each firefighting individual to affect a controlled descent from a higher to lower elevation.

2. Relevant Art

Descent control devices have been developed with the objective of lowering individuals (or objects) from a higher to lower elevation. Such devices have taken many forms and have utilized a variety of elements. Some are capable of providing a mechanical braking mechanism, such as a deadman or panic control feature, when the device would be used for descent, escape, or rescue purposes.

Concerns with occupational safety have led to the development of mechanisms that enable a worker to lower himself from an elevated position such as a scaffold, crane, lift truck or platform in the event of an emergency. That equipment is, in some respects, similar to known fire escape devices, mountain climbing equipment, and military equipment.

One descent control device with a deadman brake, in the form of a vertical cylindrical drum or capstan about which a rope is wound and a tapered slot through the drum for receiving and releasably gripping the rope, is shown in Varner et al. U.S. Pat. No. 4,883,146. That device includes plates on each end of a vertical cylindrical drum or capstan with apertures on each end plate through which the rope is threaded, then wound in two or more turns around the drum.

Tapered slots are well known for releasably fastening ropes, lines and cables. The use of cylindrical capstans for holding and providing a mechanical advantage for tightening ropes is also known. Likewise, a variety of fire escape devices utilize rope wound around a cylinder. See, for example, Budd U.S. Pat. No. 386,237; FitzGerald U.S. Pat. No. 536,866; Howe U.S. Pat. No. 771,251; Thuemer U.S. Pat. No. 946,588; Smith U.S. Pat. No. 1,115,603; Steffen U.S. Pat. No. 4,311,218; and Forrest U.S. Pat. Nos. 4,508,193 and 4,550,801.

In addition, there are known but clearly distinguishable teachings in Hobbs U.S. Pat. No. 3,678,543; Arancio U.S. Pat. No. 3,738,449; Wagner U.S. Pat. No. 4,019,609; Bell et al. U.S. Pat. No. 4,714,135; Varner et al. U.S. Pat. Nos. 5,038,888 and 5,131,491; Bassett U.S. Pat. No. 6,131,697; Harbers Jr. U.S. Pat. No. 6,585,082; Metz U.S. Pat. No. 6,817,443; Henson U.S. Pat. No. 6,823,966; and Halevy U.S. Pat. No. 7,357,224. See also, Ador Published U.S. App. No. 20020112916; Price Published U.S. App. No. 20020158098; Gelman Published U.S. App. No. 20030159887; Richardson Published U.S. App. No. 20040140152; Fischer et al. Published U.S. App. No. 20060011415; Harris Jr. Published U.S. App. Nos. 20060113147 and 20100122874; Moon et al Published U.S. App. No. 20070158139; and Botti Published U.S. App. No. 200702460298.

### SUMMARY OF THE INVENTION

It is the principal object of the present invention to provide an improved controlled descent system that can provide full body protection to all firefighter outerwear. A related object is to provide a full body EDS (i.e., both chest and legs) that can enable firemen and firewomen a fail-safe descent from the elevated levels of most any burning structure.

Firefighting personnel with an integral descent controller built into their protective gear at very little extra weight “cost”, can work better, more effectively knowing that should certain circumstances arise, they should more easily achieve a safe evacuation from the higher floors of a burning complex.

In accordance with the foregoing objects, the present invention incorporates into most any existing (or newly constructed) fire coat and pant combinations a panel housing flame resistant rope or cable, a purposefully designed control descent rack in and through which that rope/cable is wound and a friction braking handle described in more detail below.

### BRIEF DESCRIPTION OF DRAWINGS

Further features, objects and advantages of this invention will become clearer when reviewing the detailed description made with reference to the accompanying photographs in which:

FIG. 1 is a top plan view of the coat/jacket component (or Upper Unit) before zipping into a firefighter's coat or jacket;

FIG. 2 is a top plan view of an interim assembly point indicated by steps 10 and 11 of the Upper Unit construction outline below;

FIG. 3 is a top plan view of an interim assembly point indicated by steps 22 and 23 of that same Upper Unit construction outline;

FIG. 4 is a top plan view of an interim assembly point indicated by step 27 of that same Upper Unit construction outline;

FIG. 5 is a top plan view of an interim assembly point indicated by step 28 of that same Upper Unit construction outline;

FIG. 6 is a top plan view of an interim assembly point indicated by step 34 of that same Upper Unit construction outline;

FIG. 7 is a top plan view of an interim assembly point indicated by step 41 of that same Upper Unit construction outline;

FIG. 8 is a top plan view of an interim assembly point indicated by step 44 of that same Upper Unit construction outline;

FIG. 9 is a top plan view of an interim assembly point indicated by step 49 of that same Upper Unit construction outline;

FIG. 10 is a top plan view of an interim assembly point indicated by step 50 of that same Upper Unit construction outline;

FIG. 11 is a top plan view of an interim assembly point indicated by step 51 of that same Upper Unit construction outline;

FIG. 12 is a top plan view of an interim assembly point indicated by step 52 of that same Upper Unit construction outline;

FIG. 13 is a top plan view of an interim assembly point indicated by step 53 of that same Upper Unit construction outline;

FIG. 14 is a top plan view of an interim assembly point indicated by step 54 of that same Upper Unit construction outline;

FIG. 15 is a top plan view of an interim assembly point indicated by step 9 of the Coat Liner Modification construction steps outlined immediately after the Upper Unit construction outline below;

FIG. 16 is a top plan view of an interim assembly point indicated by step 11 of those Coat Liner Modification steps;

FIG. 17 is a top plan view of an interim assembly point indicated by step 18 of those Coat Liner Modification steps;

FIG. 18 is a top plan view of an interim assembly point indicated by step 26 of those Coat Liner Modification steps;

FIG. 19 is a top plan view of an interim assembly point indicated by step 6 of the Fire Pants Modification construction steps outlined immediately after the Coat Liner Modification construction steps below;

FIG. 20 is a top plan view of an interim assembly point indicated by step 8 of those Pants Modification steps;

FIG. 21 is a top plan view of an interim assembly point indicated by step 10 of those Pants Modification steps;

FIGS. 22 and 23 are side plan views of interim sub-steps from Installation Step 1 that follows the preceding Pants Modification steps outlined below;

FIG. 24 is a side plan view of an interim installation point indicated by Installation Step 2;

FIG. 25 is a front plan view of an interim installation point indicated by Installation Step 3; and

FIG. 26 is a rear plan view of an interim installation point indicated by Installation Step 8.

### DETAILED DESCRIPTION OF PREFERRED EMBODIMENTS

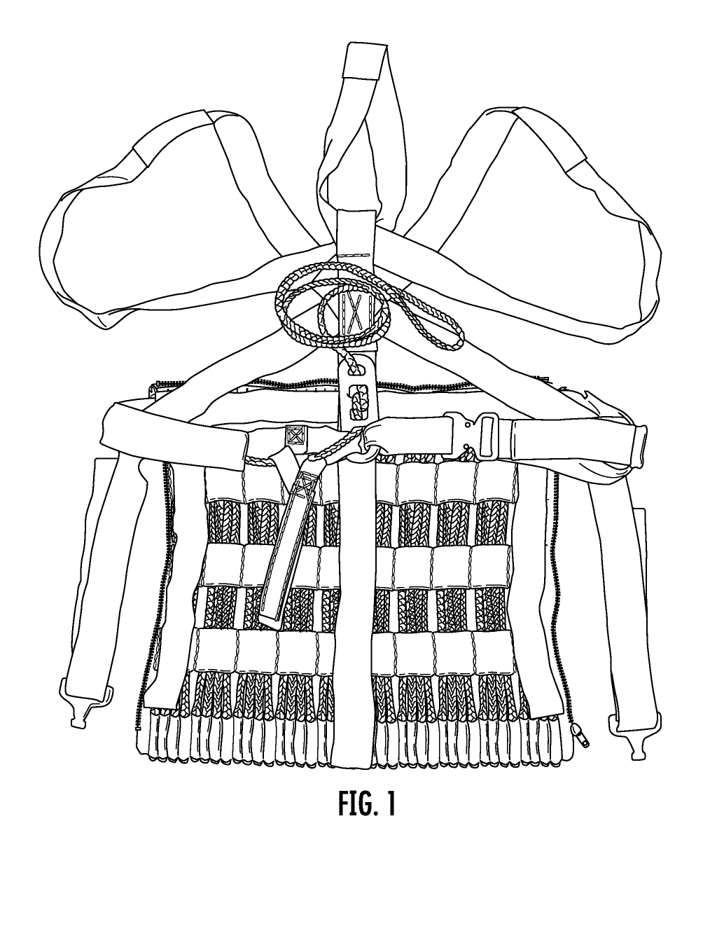

With reference to the accompanying drawing, there is shown a first preferred embodiment of FEDS, or full body emergency descent system incorporated into the protective outerwear (gear) of a firefighter according to the present invention. See, FIG. 1. Also, When referring to any numerical length, width or other number range herein, it should be noted that all such numbers are mostly representative of just one embodiment of FEDS (mostly as shown). Furthermore, any such range of numbers should expressly include each and every fraction or decimal between its stated minimum and maximum. For instance, any one component (strap, etc.) measuring from 1 to 3 inches in length should also specifically cover any strap measuring 1.1, 1.25 and 1.5 inches . . . and so on, up to about 2.75, 2.8 and 2.99 inches. The same applies for every other quantitative range herein.

Now with respect to a first, fully working prototype, note the following particulars:

### Example

### Firecoat Feds

### Components for Firecoat Feds Upper Unit

1 (1) 75″ Chest Strap, 1¾″ Kevlar Webbing, Offray #2187 Nat.
2 (1) 35″ Center Strap, 1¾″ Kevlar Webbing, Offray #2187 Nat.
3 (1) 16′ Leg/Drag Strap, 1¾″ Kevlar Webbing, Offray #2187 Nat.
4 (2) 18″ Side Straps, 1¾″ Kevlar Webbing, Offray #2187 Nat.
5 (1) 11½″ Female Buckle Strap, 1¾″ Kevlar Webbing, Offray #2187 Nat.
6 (3) 40½″ Elastic Compression Straps, 2″ FR Elastic Webbing, Offray #2645.
7 (1) 20¼″ Bottom Strap, 2″ Kevlar Webbing, Offray #1781 Blk.
8 (1) 40½″ Elastic Storage Loops, 1″ Kevlar/FR Flex Blk, Offray #1870.
9 (1) 40½″ Elastic Storage Loops, 2″ PBI/Kevlar/FR Flex Blk, Offray #2645.
10 (1) 22″ Brake Strap, 1″ Kevlar Webbing, Offray #1781.
11 (1) 6″ Brake Support, 1″ Kevlar Webbing, Offray #1781.
12 (1) 3″ Line Anchor, 1″ Kevlar Webbing, Offray #1781.
13 (1) 7″ Line Sleeve, 2″ Kevlar Tubular Webbing, Offray #2473.
14 (2) 20″ FR Nomex Zippers, Open End, Zipperstop.com.
15 (2) 16″ FR Nomex Zippers, Open End, Zipperstop.com.
16 (1) 6″ FR Reflective Tape, Identi-Tape #3M8987FR, Lime/Yellow.
17 (1) 115′ Feet of Tech 12 Line, Samson Rope Co.
18 (1) 7″ of 2″ FR Loop Velcro for Center Strap, A-B Thermal Technologies, #FAB-VHL-N-LOOP-32-B.
19 (2) 4″ of 2″ FR Loop Velcro for Leg/Drag Strap Shoulder, A-B Thermal Technologies, #FAB-VHL-N-LOOP-32-B.
20 (1) 2″ of 2″ FR Loop Velcro for Leg/Drag Strap Hand Loop, A-B Thermal Technologies, #FAB-VHL-N-LOOP-32-B,
21 (1) EDS Rack
22 (1) Complete Cobra Buckle, NFPA Model
23 (2) Male Sides of Cobra Buckle, NFPA Model

Because of its Kevlar friction brake, this invention can use technologically advanced, smaller diameter, lighter, yet stronger, flame resistant line. Particularly, the wearer/user does not have to grip the line and add friction for slowing his/her own descent. In known emergency descent systems, only ⅜″ line or larger may be used since the human hand cannot adequately grip a smaller line with sufficient force. By contrast, the preferred line for this unit can be as little as 3/16″ thick, much smaller than previously used lines, when using its EDS Rack specially designed for such lines.

Due to the smaller diameter and lighter weight of line used, much greater quantities/lengths of line can be stored allowing for safer firefighter escape from higher distances (but only when used with the Kevlar Friction Break and EDS Rack also described herein.

### Components for Firecoat Feds Coat

1 (1) 7″ of 2″ FR Hook Velcro for Center Strap—Coat, A-B Thermal Technologies, #FAB-VHL-N-HOOK-32-B.
2 (2) 4″ of 2″ FR Hook Velcro for Leg/Drag Strap Shoulder—Coat, A-B Thermal Technologies, #FAB-VHL-N-HOOK-32-B.
3 (1) 2″ of 2″ FR Hook Velcro for Leg/Drag Strap Hand Loop—Coat, A-B Thermal Technologies, #FAB-VHL-N-HOOK-32-B.
4 (1) 3″ of 1″ Loop Velcro for Center Drag Strap Slot Flap, A-B Thermal Technologies, #FAB-VHL-N-LOOP-16-B.
5 (1) 3″ of 1″ Hook Velcro for Center Drag Strap Slot Coat, A-B Thermal Technologies, #FAB-VHL-N-HOOK-16-B.
6 (2) 7½″×11½″ Nomex Fabric, Chest Strap Pockets, Offray.
7 (2) 7″×12″ Nomex Fabric, Chest Strap Pocket Flaps, Offray.
8 (2) 5″ Elastic Buckle Supports, FR 2″ Elastic Webbing, PBI/Kevlar/FR Flex Blk, Offray #2645
9 (2) 2″×2″ FR Loop Velcro, Chest Strap Pockets, A-B Thermal Technologies, #FAB-VHL-N-LOOP-32-B.
10 (2) 2′×2″ FR Hook Velcro, Chest Strap Pocket Flaps, A-B Thermal Technologies, #FAB-VHL-N-HOOK-32-B.
11 (2) 3½″ Female Buckle Straps, 1¾″ Kevlar Webbing, Offray #2187 Nat.
12 (2) Female Sides of Cobra Buckle, NFPA Model, storage of Leg Straps.

### Components for Firecoat Feds Pants

1 (2) 30″ Leg Loops, 1¾″ Kevlar Webbing, Offray #2187 Nat.
2 (2) 4½″ Leg Loop Female Buckle Straps, 1¾″ Kevlar Webbing, Offray #2187 Nat.
3 (2) 5″ Leg Female Buckle Supports, FR 2″ Elastic Webbing, PBI/Kevlar/FR Flex Blk, Offray #2645.
4 (2) 10″ of 2″ FR Loop Velcro for Leg Pocket Flap, Pants
5 (2) 10″ of 2″ FR Hook Velcro for Leg Pocket Flap
6 (2) Female Sides of Cobra Buckle, NFPA Model

With the foregoing elements all measured, cut and otherwise assembled, they should be put together according to one preferred embodiment per the following construction instructions:

### Construction—Firecoat Feds Upper Unit

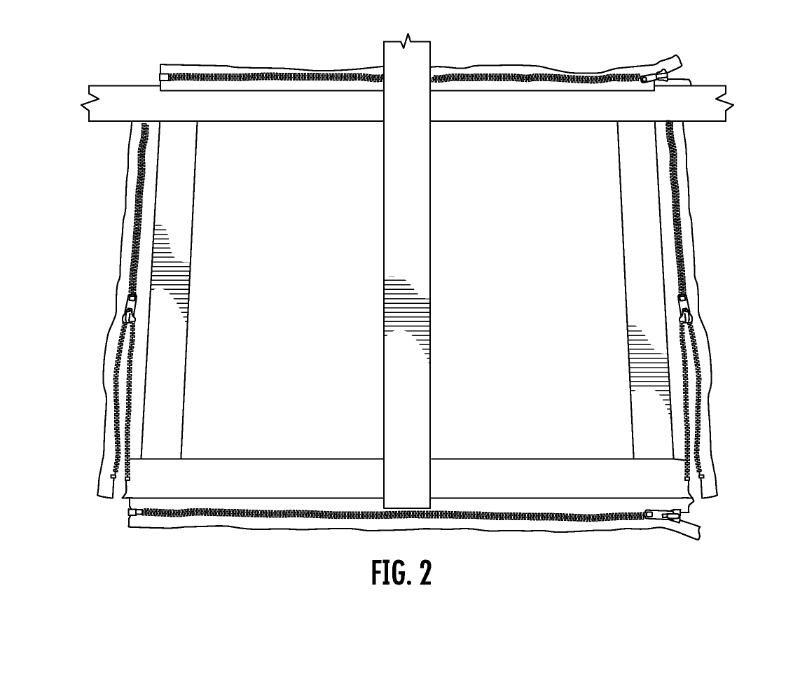

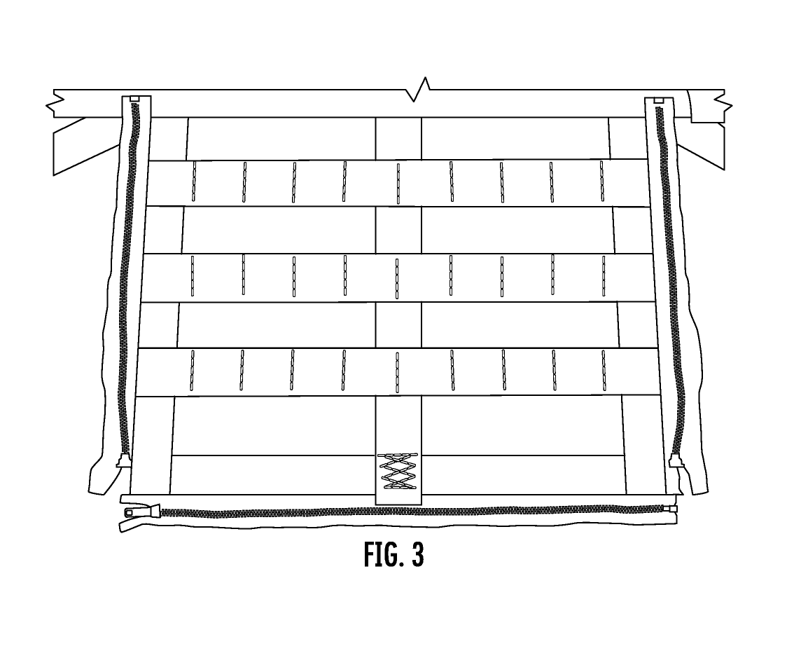

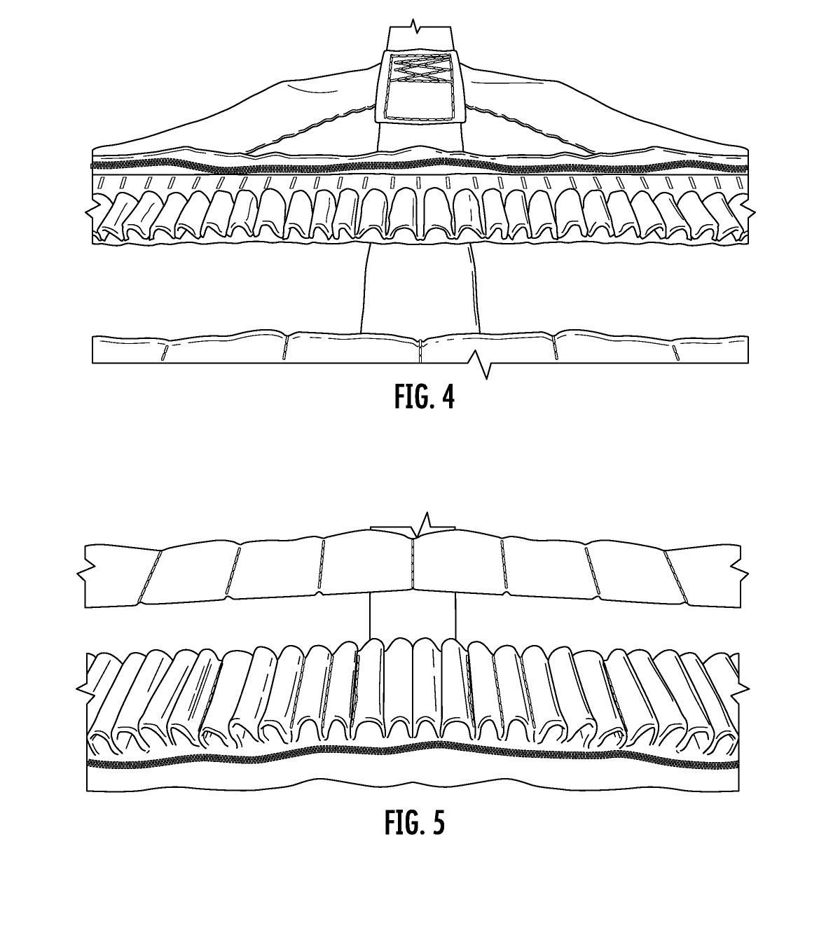

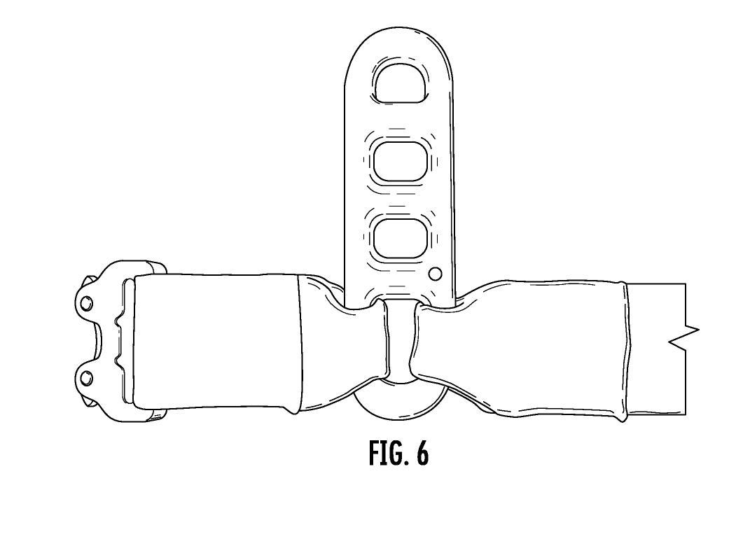

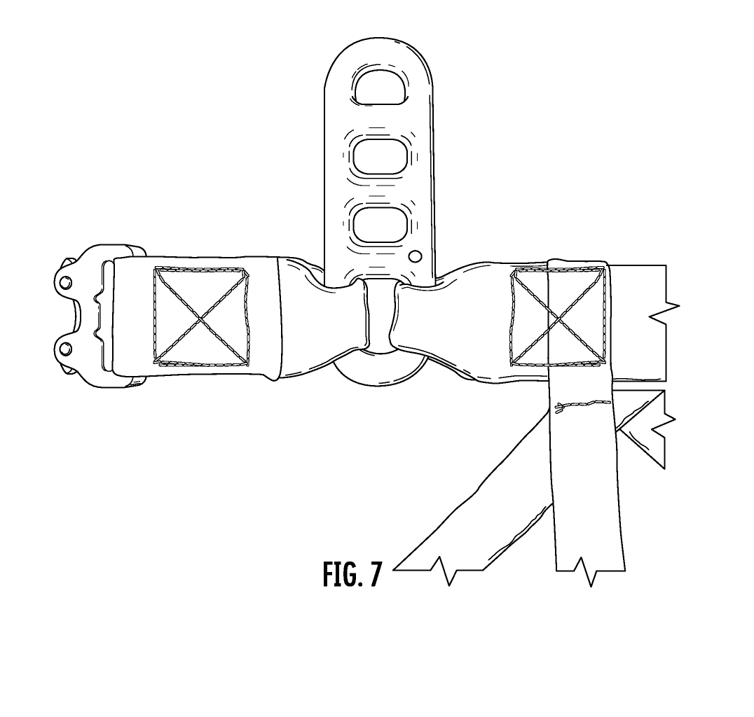

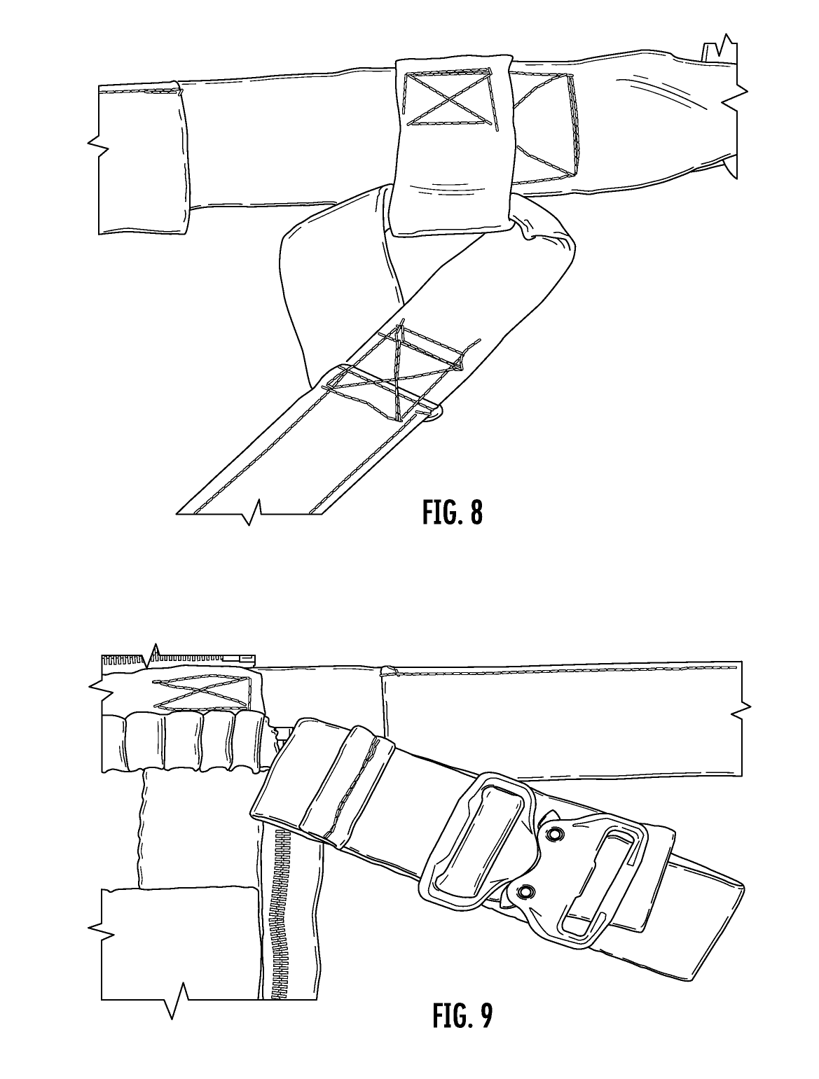

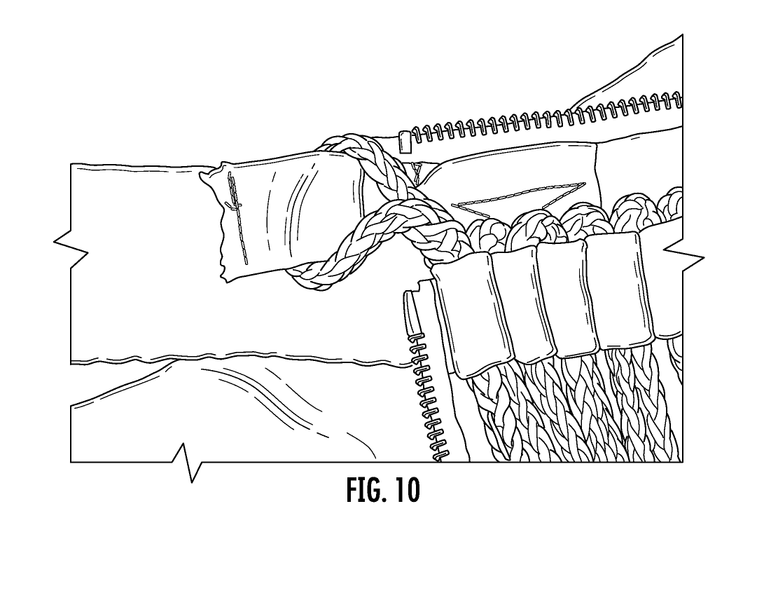

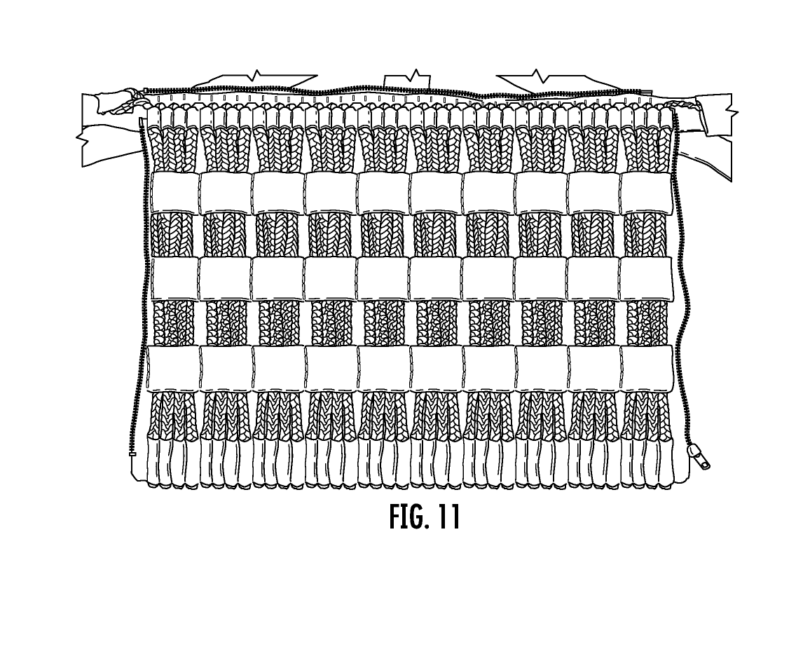

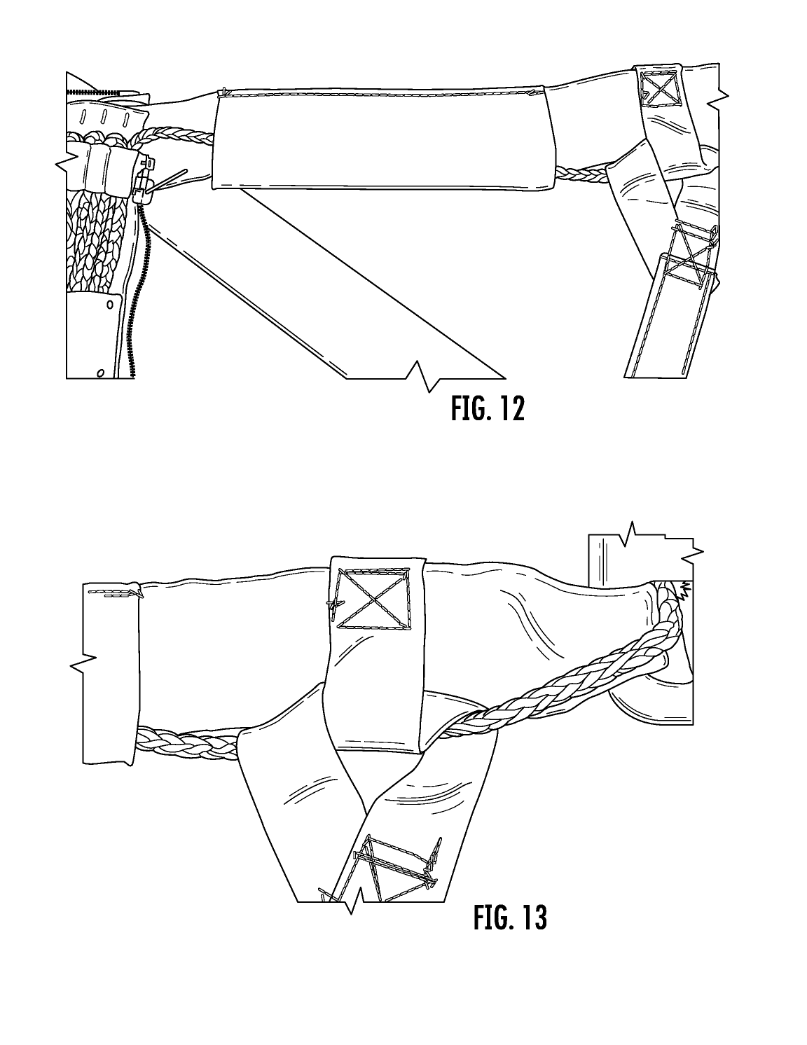

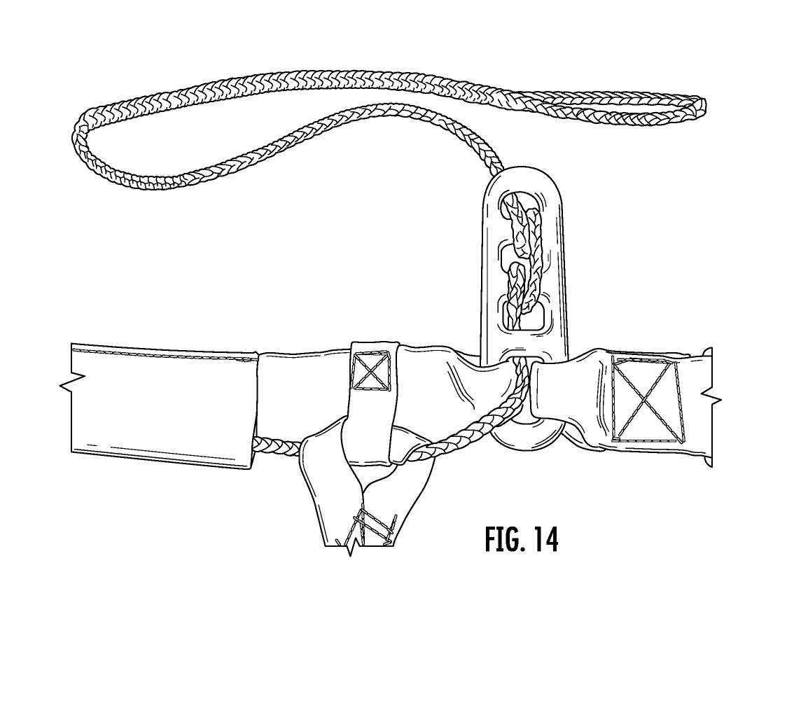

1 Hot Metal Glue (or “HMG”) a 16″ Zipper on top of each 18″ Side Strap. Both Zippers start with the closed end 1″ down from the upper edge of the Side Straps. The Zipper overlaps the Side Strap ¼″ along the outside edge. The Zipper will be on the Left side of the Left Side Strap and Right side of the Right Side Strap. Sew with 138 Kevlar Thread.
2 Lay both Side Strap with Zipper assemblies in the jig with the Zippers to the outside of the harness.
3 Mark 75″ Chest Strap on top side at 4, 8, 19, 29 (center) and 39″, and from the same end mark on the underneath side at 4, 8, 10, and 17″.
4 HMG 20″ Zipper along the upper edge of the Chest Strap between the 19 and 39″ marks. The closed end of the Zipper will be to the Left and will overlap on top of the Chest Strap ¼″ along the Upper edge.
5 Turn Chest Strap over and HMG 7″ Line Sleeve along top edge only on the Chest Strap between the 10 and 17″ marks.
6 Tri-Fold and HMG the end of the Chest Strap at the 4″ mark with folded ends on same side as Zipper.
7 Sew the Zipper and Line Sleeve along the Top Edge Only to the Chest Strap and Sew across the Tri-Fold at the 4″ mark with 138 Kevlar Thread.
8 Mark 11½″ Female Buckle Strap at 2, 4″ on one side and 4, 8″ on the other side from the same end. Tri-Fold and HMG at the 4″ mark on the same side as the 8″ mark, then Sew across the 4″ mark with 138 Kevlar Thread.
9 HMG 20″ Zipper on top of and along the lower edge of the 20¼″ Bottom Strap. The closed end of the Zipper will be to the Left and will overlap the top of the Bottom Strap ¼″ along the lower edge. Sew with 138 Kevlar Thread.
10 Place Chest Strap in jig with 29″ Center mark Centered and with the 4, and 8″ marks to the left. HMG the Chest Strap to both Side Straps. The top edge of the Chest Strap will be aligned with the top edge of both Side Straps per FIG. 2.
11 Place Bottom Strap with sewn Zipper in the jig with the Zipper closed end to the Left. HMG Bottom Strap ends EVEN with the outside edges of the Side Straps. The Bottom Strap will be slightly bunched up. The lower edge of the Bottom Strap will be aligned with the lower edges of the Side Straps. There will be 18″ between upper edge of Chest Strap and lower edge of the Bottom Strap. See, FIG. 2.
12 Mark 35″ Center Strap at 18″ and 20″ on top and mark at 20″, 27″ and 30″ on the underneath side from the same end.
13 HMG 7″ of 2″ Loop Velcro between the 20 and 27″ marks on the underneath side of the Center Strap, Sew with 138 Kevlar Thread.
14 Fold and HMG the Center Drag Strap top end back to the 20″ mark forming a loop. Only HMG the very end of the strap.
15 HMG Center Strap in jig over the Chest Strap and Bottom Strap with 18″ mark even with top of Chest Strap and bottom of Drag Strap even with the bottom of the Bottom Strap. The loop will be at the top with 7″ Velcro underneath.
16 HMG 2″×4″ Loop Velcro between 53″ and 57″ on the OPPOSITE Sides from both ends of the Leg/Drag Strap and HGM 2″×2″ Loop Velcro on the same side as the LEFT 2″×4″ Velcro, between 7′ 10″ and 8′ from the left end. Sew with 138 Kevlar Thread.
17 Place and HMG both Leg/Drag Strap ends through the formed loop extending both ends 40″ past the center of the loop with both crossing over each other just below the 30″ mark. The Leg/Drag Strap Ends below the loop will extend over both top outside corners of the Chest Strap and Side Straps.
18 Double WW Tack with Kevlar Thread the Center Strap Loop ONLY BELOW the 30″ mark, Leg/Drag Straps, Chest Strap and Bottom Strap to the Center Strap, and both Side Straps to the Chest Strap, Leg Straps and Bottom Strap.
19 Place the Harness Assembly back into the jig with the short end of the Chest Strap to the Right. The harness is upside down from the original position with the Center Drag Strap still at the upper side.
20 Fold each of the (3) 40½″ Elastic Compression Straps in half and HMG the ends together.
21 Mark the center of the Folded Elastic Compression Straps at 10⅛″ from one end and then mark every 2″ in both directions from the center mark.
22 Sew across all 2″ marks on the Elastic Compression Straps with 138 Kevlar Thread.
23 HMG the folded and sewn Elastic Compression Straps in jig with both ends of each aligned with the outside edges of the Side Straps. Upper edges will be 4, 8 and 12″ from top edge of Chest Strap. FIG. 3.
24 Double Sew outside ends to the Side Straps and Sew the center of the Elastic Compression Straps to the Center Drag Strap with 138 Kevlar Thread. See, FIG. 3.
25 Mark the Chest Strap every ½″ on the same side as the Line Sleeve along the top edge between the outside edges of the Side Straps, 41 marks.
26 Mark the Zipper on the Bottom Strap every ½″, 41 marks.
27 Mark the 40½″, 1″ and 2″Elastic Straps every 1″ with ¼″ space on each end. The first and last mark will be ¼″ from each end.
28 Sew the 40½″, 1″ Elastic Strap on the Chest Strap along the lower edge, aligning the 1″ marks on the Elastic Strap with the ½″ marks on the Chest Strap creating 40 Elastic Line Storage Loops, sew with 138 Kevlar Thread. FIG. 4.
29 Sew the 40½″, 2″ Elastic Strap on the Bottom Strap aligning the 1″ marks on the Elastic Strap with the ½″ marks on the Zipper, creating 40 Elastic Line Storage Loops, sew with 138 Kevlar Thread. FIG. 5.
30 Fold the 3″ Line Anchor in half and HMG the ends together.
31 HMG the folded Line Anchor along the top edge of the Chest Strap in the top left corner of the harness assembly with the glued ends 2″ from the outside edge of the Left Side Strap. The folded edge will be towards the Elastic Line Storage Loops.
32 Heavy Sew the Kevlar Line Anchor Strap along the glued end with 207 Kevlar Thread.
33 Place 11½″ Female Buckle Strap through the front of the bottom opening (large) in the EDS Rack, fold back short end to the 8″ mark and HMG. Looking at the EDS Rack, the Female Buckle Strap will be on the Right Side.
34 Place Female Cobra Buckle on long end of Female Buckle Strap; fold over to the 2″ mark with 2″ overlap of other folded end and HMG. The bottom side of the Cobra Buckle with the deep throat will be on the folded end side of the strap.
35 Place the Chest Strap through the front of the same bottom opening of the EDS Rack assembly. Fold back to the 8″ mark and HMG. FIG. 6.
36 Mark 6″ Kevlar Brake Support on the Left side 1¼″ from the end and on the Right side 2¼″ from the same end.
37 Mark 22″ Kevlar Brake Strap at 3, 8, and 14″ from same end.
38 HMG and Sew 6″ FR Reflective Tape on the 22″ Brake Strap between the 8 and 14″ marks with 138 Kevlar Thread.
39 Position Brake Strap on top of the Brake Support so the 3″ mark on the Brake Strap is aligned with the 1¼″ mark on the (L) side of the Brake Support and the (R) edge of the Brake Strap is aligned with the 2¼″ mark on the (R) side of the Brake Support, HMG at the 2¼″ mark.
40 Sew the Brake Strap to the Brake Support along the 2¼″ mark with 138 Kevlar Thread. The sew line is at a 90 degree angle with the long axis of the Brake Support.
41 HMG the Front of the Brake Support to the Rear of the Chest Strap next to the EDS Rack. Align the top of the Brake Support with the top edge of the Chest Strap and align the Right side of the Brake Support with the folded end of the Chest Strap.
42 Double Heavy Sew the Brake Support to the Chest Strap, the Chest Strap to the EDS Rack and the Buckle Strap between the Female Cobra Buckle and EDS Rack with 207 Kevlar Thread. FIG. 7.
43 Fold the Bottom end of the Brake Support up and over the Front of the Chest Strap.
44 The Brake Support will extend 1″ down the rear of the Chest Strap, overlapping the top end of the Brake Support. HMG and Heavy Sew with 207 Kevlar Thread.
45 HMG Brake Strap sides together at a 45 degree angle after (1) turn FOREWARDS on the (L) and (1) turn BACKWARDS on the (R). The (R) long side will be in front of and on top of (L) short side end. The top (R) corner of the Reflective Tape will align with the (R) corner of the (L) short end. FIG. 8.
46 Fold the long end of the Brake Strap underneath and HMG it to the 45 degree crossing with the end extending to the V. Double Heavy Sew Brake Strap overlaps with 207 Kevlar thread.
47 Place Male Cobra Buckle on the long end of the Chest Strap. Make sure it aligns correctly with the Female Cobra Buckle.
48 Fold the end of the Chest Strap ½″ on top TWICE, HMG between each fold and sew across with 138 Kevlar Thread.
49 Place Male Cobra Buckles on the end of both Leg Straps. The top side of the Cobra Buckle will be on the same side as the Elastic Storage Loops with the harness laid out flat.
50 Fold the ends of the Leg Straps ½″ on top TWICE, HMG between each fold and sew across with 138 Kevlar Thread. FIG. 9.
51 Insert the 115′ of 3/16″ Technora Line by starting on the left side near the Line Anchor Strap. Pull enough looped line down through the first Line Storage Loop on the Chest Strap, through the first Line Compression Strap sections and into the Bottom Strap Line Storage Loop. FIG. 10.
52 Four (4) sections of Looped Stored Line from four (4) Chest Strap Line Storage Loops will go through each Line Compression Strap Section. Each Loop of Line will extend to the bottom of the Bottom Strap Storage Loops. FIG. 11.
53 Once all Storage Loops are filled, place the Line through the Line Sleeve. FIG. 12.
54 Then place the Line through the Brake. FIG. 13.
55 And finally thread the Line through the EDS Rack as shown. FIG. 14.

### Construction is Completed on Firecoat Feds Upper Unit

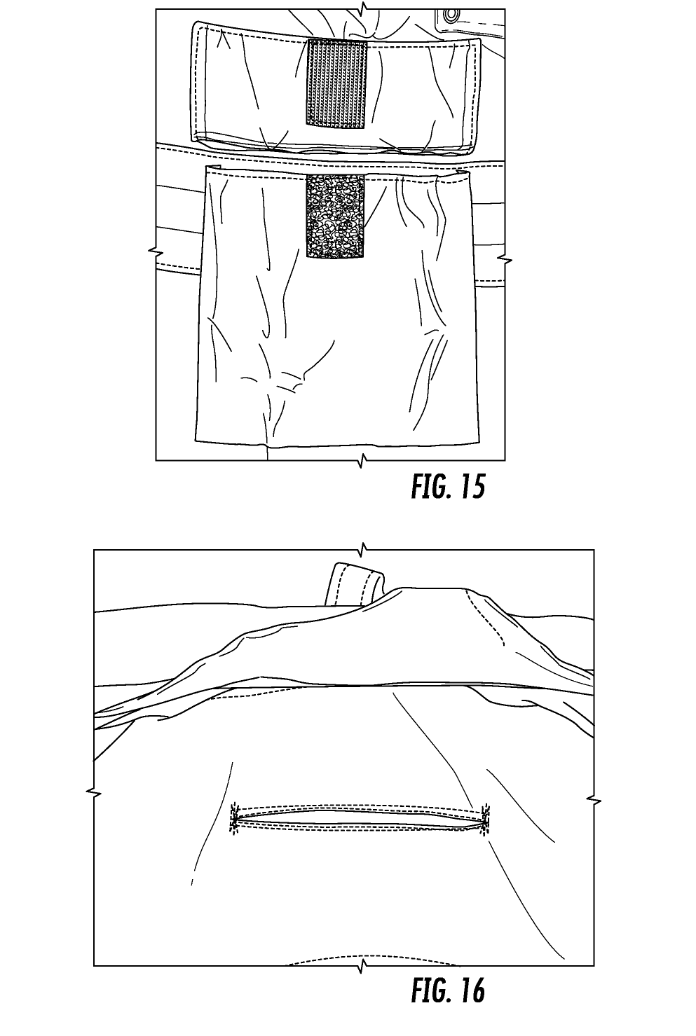

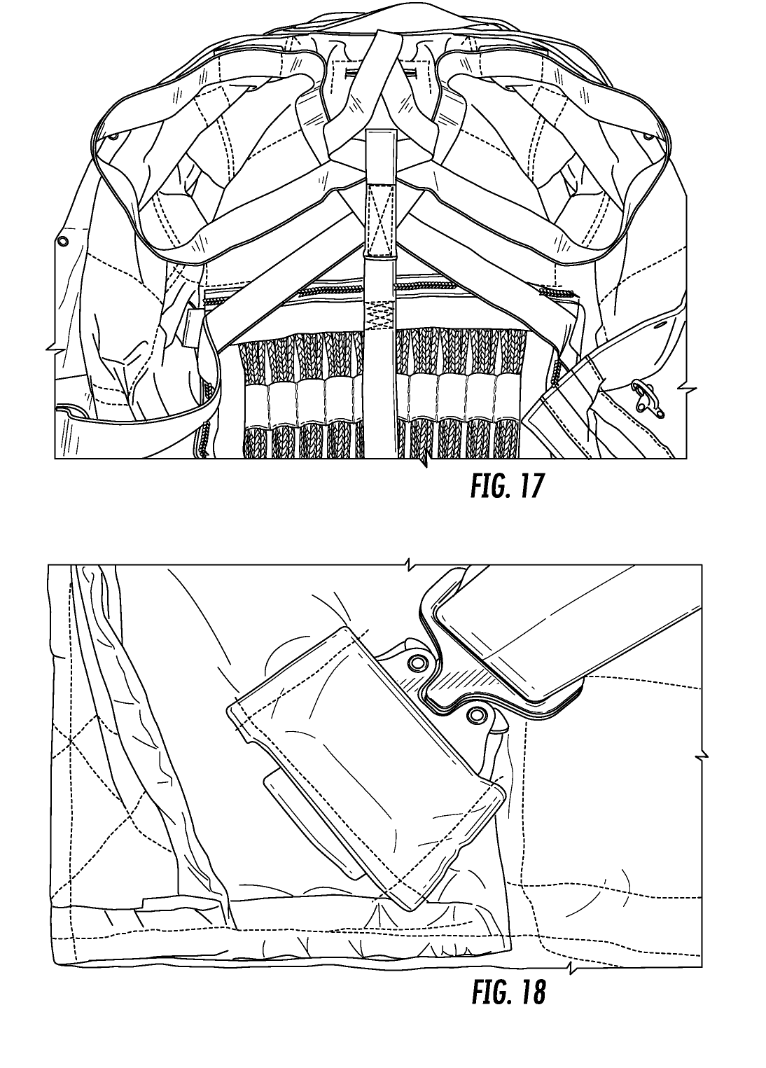

There are preferred instructions for affecting modifications to an existing firefighter's coat to accept the Firecoat FEDS Upper Unit described above. First, the original equipment coat liner must be removed. Then:
1 Mark and Sew a Vertical 3½″ Chest Strap Slot opening 2″ posterior and 1″ lower than the Top Mid Axillary Line on inside of coat on both sides.
2 Form the Chest Strap Pockets starting with a 7½″×11½″ piece of Nomex fabric. Mark 1″ around all inside edges, fold edges inward ½″ to line and HMG, ending with a 6½″×10½″ piece.
3 HMG 2″ of 2″ Loop Velcro on the outside upper center of the formed Chest Strap Pocket.
4 Sew Velcro to pocket and along the length of the upper edge with 138 Kevlar Thread.
5 Form the Chest Strap Pocket Flap starting with 12″×7″ Nomex Fabric. Fold in half and HMG the ends together to form a 12″×3½″ piece.
6 Make a 1″ mark around the HMG ends and fold over ½″ to those marks and HMG. Do not fold over the folded side of fabric.
7 HMG 2″ of 2″ Hook Velcro on the Folded Lower Inside Center of the Flap. Sew the Velcro to the Lower Inside Center of the Flap and along both sides and bottom with 138 Kevlar Thread.
8 HMG the 6½″×10½″ Chest Strap Pocket to the coat ½″ posterior to the 3½″ Vertical Slot. The top of the Pocket will be even with the top of the Slot. Bunch the Chest Strap Pocket ½″ so it is only 10″ wide.
9 HMG the Chest Strap Pocket Flap 1″ above the pocket, aligning the matching Velcro. FIG. 15.
10 Sew the Chest Strap Pockets and Flaps to the coat with 138 Kevlar Thread.
11 Mark and Sew a 5″ horizontal Center Drag Strap Slot centered and 2″ below the neck collar with 138 Kevlar Thread. FIG. 16.
12 HMG and Sew 2″ of 2″ Hook Velcro on the inside of the coat centered above and adjoining the Center Drag Strap Slot.
13 HMG and Sew 3″ of 1″ Hook Velcro on the outside of the coat centered along the Lower edge of the Center Drag Strap Slot.
14 Form a Drag Strap Slot Flap starting with 8″×3″ Nomex fabric. Fold all sides over ½″.
15 HMG 3″ of Loop Velcro centered along the lower inside long edge of the Drag Strap Slot Flap.
16 Sew the Loop Velcro to the Center Drag Strap Slot Flap and sew across the same long lower side.
17 HMG and Sew the Center Drag Strap Slot Flap along both sides and upper edge over the outside of the Slot starting the Flap ½″ above the Slot and aligning the matching Velcro.
18 Lay the FireCoat FEDS Upper Unit on the inside of the coat, centering and aligning the Chest Straps with the Chest Strap Slots upper ends. FIG. 17.
19 HMG the un-sewn Zipper sides to the inside of the coat.
20 Extend the Center Strap and HMG 7″ of Hook Velcro to the inside of the coat aligning it with the loop Velcro attached underneath the Center Strap.
21 HMG inside of both coat shoulders 4″ of Hook Velcro 1″ from the neckline and extending down the front of the coat in line with the Top Shoulder Seam.
21 Unzip all Zippers and remove the FireCoat FEDS Upper Unit from the coat.
22 Create the Coat Storage Buckle by placing the 3½″ Coat Female Buckle Strap thru the Female Cobra Buckle and HMG the ends of the strap together.
23 HMG the Coat Storage Buckle and Strap to the inside lower corner of the coat. Place the Female Buckle at a 45% angle facing back up towards the top outside corner of the harness on that side. The underneath side of the buckle with the deep throat will be facing up.
24 Sew the Buckle Strap to the coat with 138 Kevlar Thread.
25 Fold the 5″ Elastic Buckle Support ends over ½″ and HMG.
26 HMG and Sew the sides and bottom edge of the Elastic Buckle Support over the Coat Storage Buckle. The top edge of the Elastic Support will be even with the bottom of the Female Buckle Throat. FIG. 18.
27 Sew all Zippers, the 7″ Center and both 4″ Shoulder Hook Velcro to the coat.

### Modifications to the Original Outer Coat are Complete

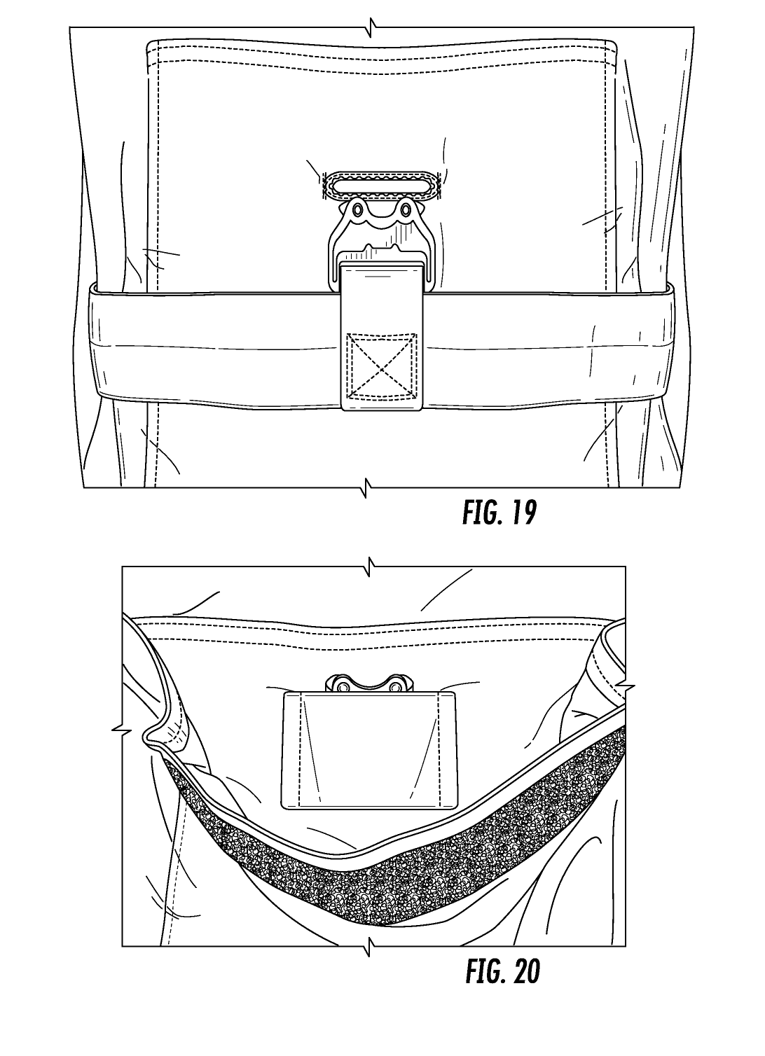

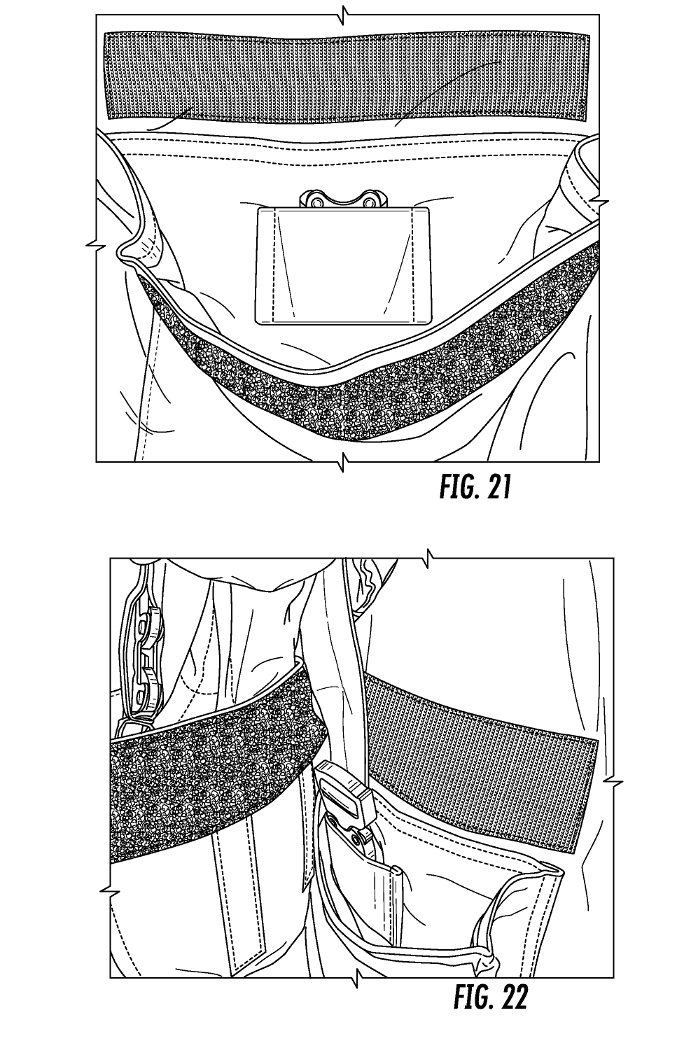

There are similar “preferred” instructions for making modifications to existing fire pants to accept/accommodate the Firecoat FEDS leg straps described herein. Like the original outer coat above, start by removing the original pants liner, outside leg pocket sides and flap. Then:
1 Form the Leg Loops by over lapping 2″ of the 30″ Leg Loop Webbing, HMG.
2 HMG 4½″ Female Cobra Buckle Strap and Buckle over the upper edge of the overlapped area of the Leg Loop. Double Heavy Sew with 207 Kevlar Thread. The underneath side of the Female Buckle with the deep throat is facing out.
3 Turn pants inside out and Mark along the inside or medial seam even with the top of the leg or where the crotch begins. This is the location of the upper edge of the Leg Loop.
4 Measure and Mark along this same line to the Outside or Lateral Seam.
5 At this Centered Outside location, Mark and Sew a 2½″ Horizontal Leg Buckle Slot centered with the lateral seam. This point will be approx. 2″ below the top edge of the Outside Leg Pocket.
6 Insert the Female Cobra Buckle thru the slot, align and HMG the Leg Loop to the pant leg with the inside segment in the upper crotch. Sew Leg Loops to the pant legs with Kevlar Thread. FIG. 19.
7 Fold the both ends of the 5″ Elastic Buckle Support ½″ and HMG.
8 Turn pants right side out, HMG and Sew the Elastic Buckle Support over the exposed Female Buckle, extending ¾″ on both sides. The top of the Support will be even with the Rivets on the Buckle. FIG. 20.
9 HMG and Sew the proper length of 2″ Loop Velcro along the Underside Top Edge of the Leg Pocket Flap to allow for 1″ open area on the posterior or rear side. The Velcro will be towards the Front or Anterior side of the Flap underneath.
10 HMG and Sew the Matching Length of 2″ Hook Velcro along the top edge of the Leg Pocket to allow for 1″ open area on the posterior or rear side. FIG. 21.
11 HMG and Sew the Leg Pocket Flap in place by sewing the 1″ open area along the top edge only.

### All Original Equipment Modifications for the Firecoat Feds are Complete

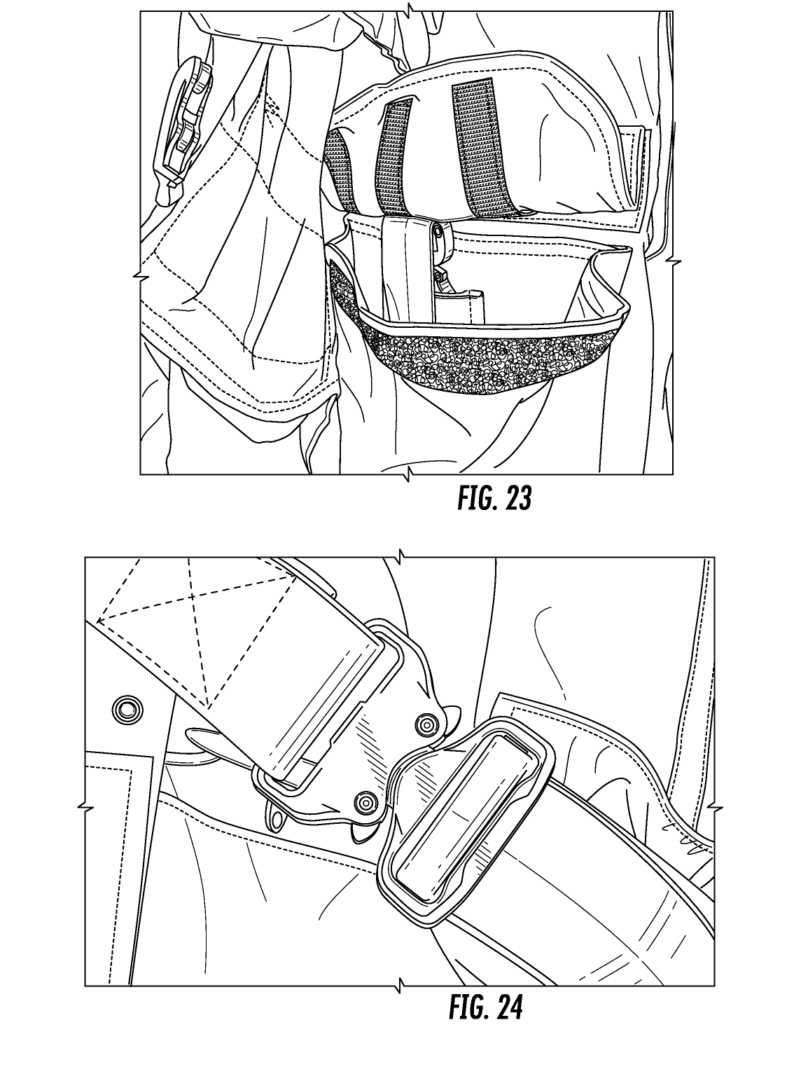

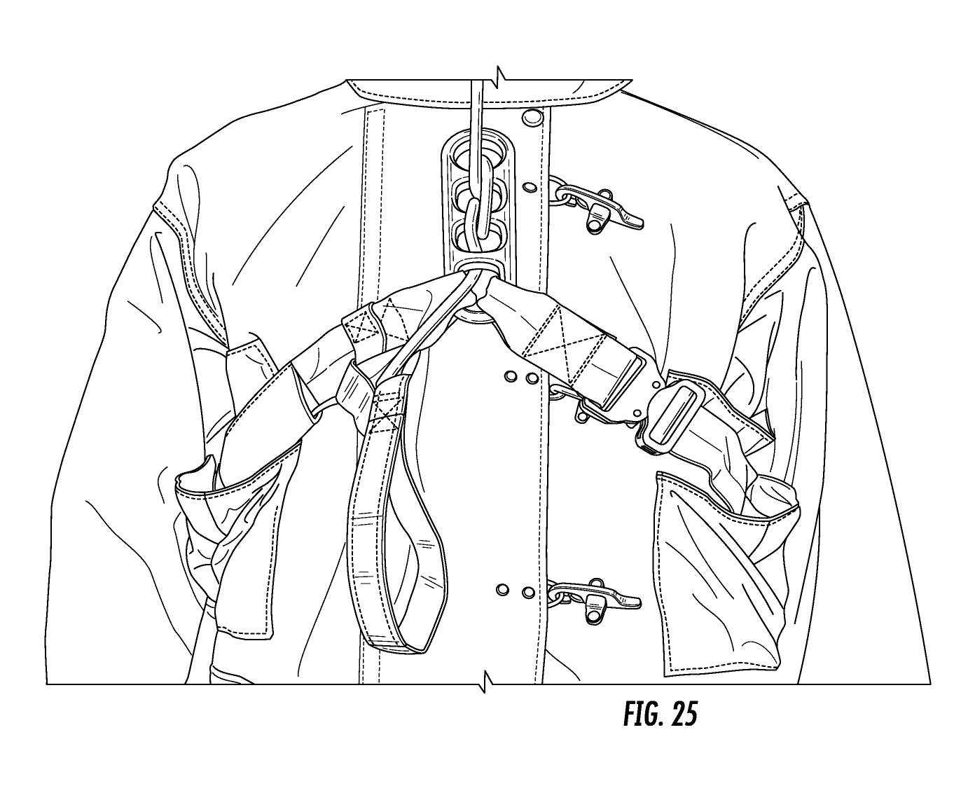

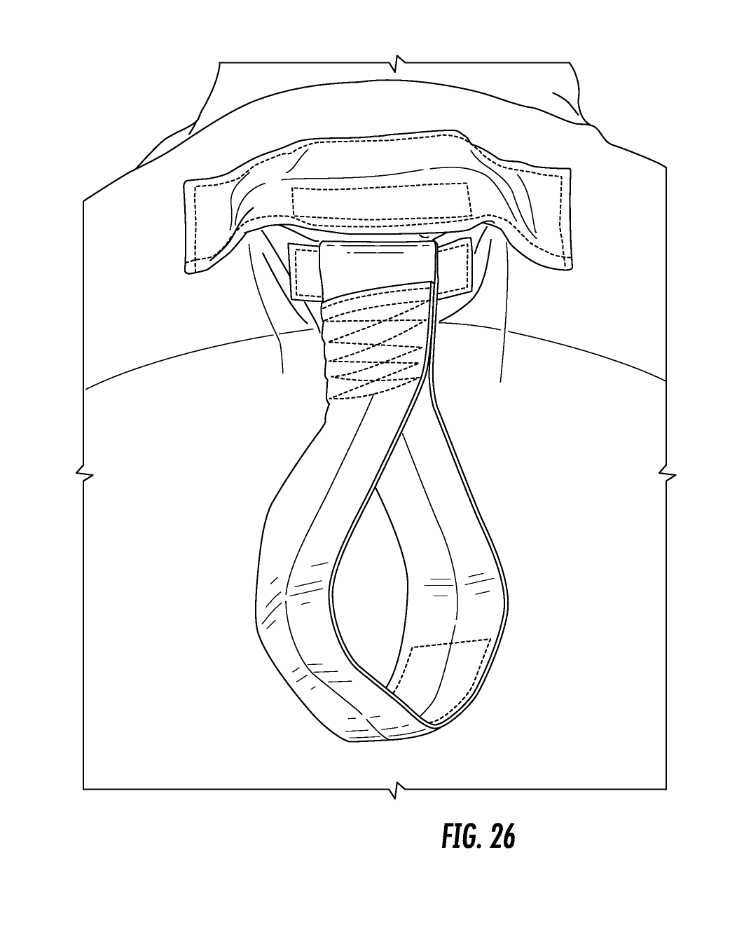

Lastly, consider the following preferred instructions for putting on a fitted FIRECOAT FEDS along with instruction on using the Emergency Descent System now added to the firefighter's coats and pants. Particularly:
1 Before closing the coat, attach the FireCoat FEDS Leg Straps to the Pants Leg Loops forming a Fullbody Harness. Lift the corner of the coat, remove the Leg Strap Male Buckle from the Coat Storage Buckle (FIG. 22), peel back the Pant Pocket Flap (FIG. 23) and insert the Leg Strap Male Buckle into the Leg Loop Female Buckle inside the Leg Pocket. Snug the Leg Strap, place the free end of the strap into the pocket and replace Pocket Flap. Continue to buckle the coat front closed.
2 TO PERFORM AN EMERGENCY DESCENT FROM AN UNSAFE POSITION USING THE FIRECOAT FEDS, remove both Chest Strap ends from both Chest Pockets and connect the Cobra Buckle ends. FIG. 24.
3 This places the Chest Strap with EDS, Line and Brake in front of the Fireman. FIG. 25.
4 Attach the end of the Line to a firm anchor capable of withstanding the forces placed on it by the Fireman's weight while descending.
5 The Fireman can expose additional Line by backing up or by pulling Line from the stored position by shoving down on the Line between the Brake and EDS Rack and then letting it transition up thru the EDS Rack.
6 To start a descent, PLACE BOTH HANDS IN THE BRAKE HANDLE LOOP, GRIPPING IT TIGHTLY. TO SLOW OR STOP YOUR DESCENT FIRMLY PULL DOWN ON THE BRAKE HANDLE LOOP TOWARDS YOUR FEET.
7 To descend, YOU MUST REDUCE ENOUGH PRESSURE ON THE BRAKE TO ALLOW FOR THE LINE TO TRANSITION FROM THE STORAGE LOOPS AND UP OUT OF THE EDS RACK.
8 TO ACCESS THE DRAG STRAP LOOP, open the Outside Collar Slot and pull out the Drag Loop from its stored position. FIG. 26.

While certain illustrative embodiments have been shown in the drawings and described above in considerable detail, it should be understood that there is no intention to limit the invention to the specific forms disclosed.

What is claimed is:

1. A full body emergency descent system for incorporating into a firefighter's coat and pants, said emergency descent system comprising:
a panel having a pair of chest straps that store into the coat until needed and fasten together when needed, said panel also having a plurality of rope holders at opposite ends for holding in a back-and-forth wound pattern a flame resistant rope that has a free end adapted for anchoring to a fixture for the firefighter to effect a gradual descent to a safer elevation;
a pair of leg straps incorporated in the firefighter's pants and having buckle connections to the panel in the firefighter's coat to form a full body harness;
a control descent rack in and through which the rope is wound; and
a friction braking handle.

2. The emergency descent system of claim 1, which includes at least about 75 feet of flame resistant rope.

3. The emergency descent system of claim 2, which includes at least 100 feet of flame resistant rope.

4. The emergency descent system of claim 1, which further includes a drag strap loop.

5. The emergency descent system of claim 4 wherein said drag strap loop extends through a central aperture in an upper rear portion of the firefighter's coat.

6. The emergency descent system of claim 1, which can be used to modify existing firefighter coat and pants.

7. The emergency descent system of claim 1, which can be incorporated into newly constructed firefighter coat and pants.

8. The emergency descent system of claim 1, which is available in an adult or teen size.

9. The emergency descent system of claim 1, which can be worn by a firefighter weighing up to 375 lbs.

10. The emergency descent system of claim 1 wherein the rope is held on the panel in a plurality of vertical back-and-forth extensions.

11. A full body emergency descent system for incorporating into a firefighter's coat and pants, said emergency descent system comprising:
a panel having a pair of chest straps that store in the coat until needed and buckle to one another when needed, said panel having a plurality of rope holders at opposite ends for holding in a back-and-forth substantially vertically extending pattern a flame resistant rope that has a free end adapted for anchoring to a fixture for the firefighter to effect a gradual descent to a safer elevation;
a pair of leg straps incorporated in the firefighter's pants and having buckle connections to the panel in the firefighter's coat to form a full body harness;
a control descent rack having a plurality of apertures in and through which said rope is threaded in a predetermined pattern; and
a friction braking handle for the firefighter to use for slowing descent rate or stopping altogether.

12. The emergency descent system of claim 11, which includes at least about 75 feet of flame resistant rope.

13. The emergency descent system of claim 12, which includes at least 100 feet of flame resistant rope.

14. The emergency descent system of claim 11, which further includes a drag strap loop that extends through a central aperture in an upper rear portion of the firefighter's coat.

15. The emergency descent system of claim 11, which can be used to modify existing firefighter coat and pants.

16. The emergency descent system of claim 11, which can be incorporated into newly constructed firefighter coat and pants.

17. The emergency descent system of claim 11, which is available in an adult or teen size.

18. The emergency descent system of claim 11, which can be worn by a firefighter weighing up to 375 lbs.

19. A full body emergency descent system for retrofitting an existing firefighter's coat and pants, said emergency descent system comprising:
a panel having a pair of chest straps that store in the coat until needed and buckle to one another when needed, said panel having a plurality of rope holders at opposite ends for holding in a back-and-forth substantially vertically extending pattern at least 75 feet of flame resistant rope, said rope having a free end adapted for anchoring to a fixture for the firefighter to effect a gradual descent to a safer elevation;
a pair of leg straps incorporated in the firefighter's pants and having buckle connections to the panel in the firefighter's coat to form a full body harness;
a control descent rack having a plurality of apertures in and through which said rope is threaded in a predetermined pattern; and
a friction braking handle for the firefighter to use for slowing descent rate or stopping altogether.

20. The emergency descent system of claim 19, which further includes a drag strap loop that extends through a central aperture in an upper rear portion of the firefighter's coat.
